(19) United States
(12) Patent Application Publication
(10) Pub. No.: US 2025/0304482 A1
(43) Pub. Date: Oct. 2, 2025

(54) GLASS FORMING APPARATUS AND METHOD FOR FORMING A GLASS RIBBON

(71) Applicant: CORNING INCORPORATED, CORNING, NY (US)

(72) Inventors: Steven Roy Burdette, Big Flats, NY (US); Justin Shane Starkey, Painted Post, NY (US); Brandon Thomas Sternquist, Corning, NY (US); Patrick Michael Thornton, Corning, NY (US)

(21) Appl. No.: 18/851,756

(22) PCT Filed: Apr. 20, 2023
(86) PCT No.: PCT/US2023/019193

§ 371 Date: Sep. 27, 2024

Related U.S. Application Data
(60) Provisional application No. 63/336,571, filed on Apr. 29, 2022.

(51) Int. Cl. C03B 17/06

(52) U.S. Cl. CPC C03B 17/068; C03B 17/064

(57) ABSTRACT

A glass forming apparatus configured to form a molten glass ribbon is disclosed, the glass forming apparatus including an edge director assembly positioned to immerse at least a portion of a wire immersion tool in an edge portion of the molten glass ribbon to mitigate lateral contraction of the molten glass ribbon and improve stability of the edge portion. A method of forming a glass ribbon using the edge director is also disclosed.

### CROSS REFERENCE TO RELATED APPLICATION

This application claims the benefit of priority under 35 U.S.C. § 119 of U.S. Provisional Application Ser. No. 63/336,571 filed on Apr. 29, 2022, the content of which is relied upon and incorporated herein by reference in its entirety.

### FIELD

The present disclosure relates to a glass forming apparatus, and in particular a glass forming apparatus for forming a glass ribbon using edge directors with wire immersion tools.

### BACKGROUND

Forming glasses with low liquidus viscosity (e.g., 1 kiloPoise (kP) to about 10 kP) is not easily accomplished using a typical fusion process wherein molten glass is flowed over converging forming surfaces joined at a bottom edge and then drawn therefrom as a glass ribbon. To optimize the glass ribbon attributes it may be desirable to reduce edge flow density, which can destabilize the edges of the ribbon. Under these conditions, molten glass may build up and drip from portions of the forming body or lateral contraction of the ribbon may cycle in a periodic manner. Both of these forms of edge instability may prevent stable operation of the process.

Typically, the ribbon edge viscosity is higher than the ribbon center in glass ribbon forming processes. As the ribbon center viscosity is reduced to stay below the liquidus viscosity, viscosity at the ribbon edges is also reduced and edges become destabilized.

Edge directors have been in use in fusion processes since its inception to maintain ribbon width and to help stabilize the flow of molten glass at the ribbon edges. Typical edge directors are attached to the forming body and made from sheets of platinum or platinum alloy, making them impossible to change during operation of the process and therefore requiring long downtime to repair damage. Such edge directors are also challenging to heat, so devitrification can form on the glass contact surfaces of the edge directors.

### SUMMARY

Edge directors are described herein that spaced apart from the forming body. Such edge directors may comprise one or more wires shaped to help stabilize the flow of molten glass at the edges of a formed ribbon and may be easily heated with electrical current through the wire(s) when needed. Wires have both low surface area to dissipate heat and low cross-sectional area to reduce electrical current requirements.

Edge directors that employ one or more wires that are at least partially immersed in the flow of molten glass may be easily replaced in the case of damage or a process change requiring a different design. For example, the wire(s) may be incorporated into a housing or other fixture than can be withdrawn from the forming process, for example a cartridge design, so the wire portion of the edge director can be repaired or replaced. Wire for immersion into the flow of molten glass can be easily fabricated by bending. Modeling has shown such wire forms can be effective at maintaining ribbon width and flow stability. In some glass forming processes, high flow rates may be required for successful ribbon formation, but which flow rates are impractical for production. Wire edge directors have been shown to collect sufficient flow (e.g., to slow the flow of molten glass) such that the ribbon edge is stable when it leaves the wire. Without wishing to be bound to theory, it is believed higher flow at the edge portions of the molten glass ribbon will allow wire edge directors that have a downward-extending wire very near the edge dam can maintain ribbon width very close to the forming body length.

Accordingly, in a first aspect, a glass forming apparatus is disclosed comprising a forming body comprising a first end and a second end opposite the first end and configured to receive a flow of molten glass and wherein the molten glass flows from the forming body as a molten glass ribbon along a draw plane. The glass forming apparatus further comprises an edge director assembly comprising a wire immersion tool arranged below the forming body and positioned such that the wire immersion tool extends in a direction from the first end toward a first vertical plane extending through the forming body orthogonal to the draw plane and bisecting the forming body, at least a portion of the immersion tool positioned between the first vertical plane and a second vertical plane parallel to the first vertical plane and coincident with the first end of the forming body.

In a second aspect, a maximum diameter of the wire immersion tool of the first aspect is in a range from about 1 mm to about 10 mm.

In a third aspect, the wire immersion tool of any of the first or second aspects comprises a platinum group metal.

In a fourth aspect, the wire immersion tool of any of the first through the third aspects is movable in a vertical direction.

In a fifth aspect, the wire immersion tool of any of the first through the fourth aspects is movable in a horizontal direction.

In a sixth aspect, the wire immersion tool of any of the first through the fifth aspects is rotatable about an axis of rotation parallel to the draw plane.

In a seventh aspect, the wire immersion tool of any of the first through the sixth aspects is rotatable about a horizontal axis orthogonal to the draw plane.

In an eighth aspect, the forming body of any of the first through the seventh aspects comprises a pair of converging forming surfaces joining along a bottom edge of the forming body, the bottom edge lying in the draw plane.

In a ninth aspect, the glass forming apparatus of any of the first through the eighth aspects may further comprise a forming roll rotatable about an axis of rotation and positioned below and spaced apart from the edge director, the forming roll positioned to receive the molten glass ribbon on a surface thereof.

In a tenth aspect, the glass forming apparatus of the ninth aspect may further comprise a pair of counterrotating pulling rolls positioned below and spaced apart from the forming roll, the pair of counterrotating pulling rolls arranged to receive therebetween a second glass ribbon from the forming roll.

In an eleventh aspect, the wire immersion tool of any of the first through the tenth aspects may be connected to an electrical power supply configured to pass an electrical current through the wire immersion tool.

In a twelfth aspect, the wire immersion tool of any of the first through the eleventh aspects may comprise an electrically conductive sheath disposed about the wire immersion tool and an electrically isolating material disposed between the wire immersion tool and the electrically conductive sheath that electrically isolates the wire immersion tool from the electrically conductive sheath.

In a thirteenth aspect, the electrically conductive sheath of the twelfth aspect may comprise platinum.

In a fourteenth aspect, the electrically isolating material of the thirteenth aspect may comprise a ceramic refractory material.

In a fifteenth aspect, the glass forming apparatus of the fourth aspect may further comprise a DC power supply electrically connected between the forming body and the edge director.

In a sixteenth aspect, the glass forming apparatus of any of the eleventh through the fourteenth aspects may further comprise a DC power supply electrically connected between the forming roll and the sheath.

In a seventeenth aspect, the edge director assembly of any of the first through the sixteenth aspects may be positioned below and spaced apart from the forming body.

In an eighteenth aspect, a method of forming a glass ribbon, comprising flowing molten glass from a forming body as a molten glass ribbon, and contacting an edge portion of the molten glass ribbon with an edge director assembly, the edge director comprising a wire immersion tool at least partially immersed in the edge portion.

In a nineteenth aspect, the edge director assembly of the eighteenth aspect may be positioned below and spaced apart from the forming body.

In a twentieth aspect, the method of any one of the eighteenth through the nineteenth aspects may further comprise heating the wire immersion tool with an electrical current directed therethrough.

In a twenty first aspect, a DC power supply may be connected between the edge director and the forming roll, the method of the twentieth aspect further comprising controlling adhesion of the molten glass layer to the forming roll by controlling at least one of a voltage or an electrical current supplied by the DC power supply.

In a twenty second aspect, the method of the twenty first aspect may further comprise controlling the voltage in a range from about-3 volts to about +3 volts.

In a twenty third aspect, the method of the twenty first aspect may further comprise, controlling the electrical current in a range from about 0 amps to about 5 amps.

In a twenty fourth aspect, the method of the twentieth aspect may further comprise a DC power supply connected between the edge director assembly and the forming body.

In a twenty fifth aspect, the edge director assembly of the twenty first or the twenty fourth aspects may comprise an electrically conductive sheath disposed about the wire immersion tool, an electrically isolating material is disposed between the electrically conductive sheath and the wire immersion tool, and the DC power supply is electrically connected to the electrically conductive sheath.

In a twenty sixth aspect, the method of any one of the eighteenth through the twenty fifth aspects may further comprise receiving the molten glass ribbon on a rotating forming roll spaced apart from and below the edge director, the molten glass ribbon forming a molten glass layer over at least a portion of the forming roll.

In a twenty seventh aspect, the method of the twenty sixth aspect may further comprise drawing the molten glass layer from the forming roll as a second glass ribbon.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is an elevational front view of an exemplary glass forming apparatus;

FIG. 2 is a front view showing a portion of the glass forming apparatus of FIG. 1 wherein the molten glass ribbon descending from the bottom edge of the forming body without edge directors breaks into multiple streams;

FIG. 3 is an elevational front view of another exemplary glass forming apparatus;

FIG. 4 is a cross-sectional side view of the glass forming apparatus of FIG. 3;

FIG. 5 is a front view of an edge director of the glass forming apparatus of FIG. 4, the edge director including a wire immersion tool;

FIG. 6 is a front view of another edge director of the glass forming apparatus of FIG. 4 including another exemplary immersion tool;

FIG. 7 is a front view of another edge director of the glass forming apparatus of FIG. 4 including still another exemplary immersion tool;

FIG. 8 is a front view of another edge director of the glass forming apparatus of FIG. 4 including yet another exemplary immersion tool;

FIG. 9 is a front view of another edge director of the glass forming apparatus of FIG. 4 including another exemplary immersion tool;

FIG. 10 is a front view of another edge director of the glass forming apparatus of FIG. 4 including still another exemplary immersion tool;

FIG. 11 is a front view of another edge director of the glass forming apparatus of FIG. 4 including yet another exemplary immersion tool;

FIG. 12 is a front view of another edge director of the glass forming apparatus of FIG. 4 including another exemplary immersion tool;

FIG. 13 is a front view of the edge director and immersion too of FIG. 11, showing an electrical power supply connected to the edge director, and more particularly, to the immersion tool;

FIG. 14 is an end view of an exemplary immersion tool illustrating out-of-plane rotation of the immersion tool about an axis of rotation (e.g., a longitudinal axis of a segment of the immersion tool);

FIG. 15 is a side view of an exemplary edge director according to an embodiment disclosed herein;

FIG. 16 is a cross-sectional view of a portion of the immersion tool of FIG. 15 comprising an electrically conductive sheath and an electrically isolating layer; and

FIG. 17 is a schematic view of an exemplary edge director assembly comprising a first DC power supply electrically connected between an immersion tool and a forming roll, and a second DC power supply electrically connected between a forming body and the immersion tool.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, within about 2% of each other, or within 1% of each other.

As used herein, the term “molten glass” in the context of a first molten glass ribbon means a molten material with a viscosity in a range from about 100 Pascal·seconds (1000 Poise) to about 20,000 Pa·s (200,000 Poise), for example in a range from about 100 Pas to about 15,000 Pa·s, in a range from about 100 Pas to about 12,500 Pas, in a range from about 100 Pa·s to about 10,000 Pa·s, in a range from about 7,500 Pa·s, in a range from about 100 Pa·s to about 5,000 Pas, or in a range from about 100 Pas to about 2,500 Pa·s, including all ranges and subranges therebetween, the molten material formulated such that with appropriate cooling, the material may form a glass, for example a silicate glass (e.g., borosilicate, aluminoborosilicate, low alkali metal or alkali metal free aluminoborosilicate, etc.). Edge directors disclosed herein, while useful over the preceding viscosity ranges, may be particularly useful for molten glass (e.g., first molten glass ribbon) with a viscosity in a range from about 100 Pas to about 1000 Pas, such as in a range from about 100 Pas to about 750 Pa·s, in a range from about 100 Pas to about 500 Pas, or in a range from about 100 Pas to about 250 Pa·s, including all ranges and subranges therebetween.

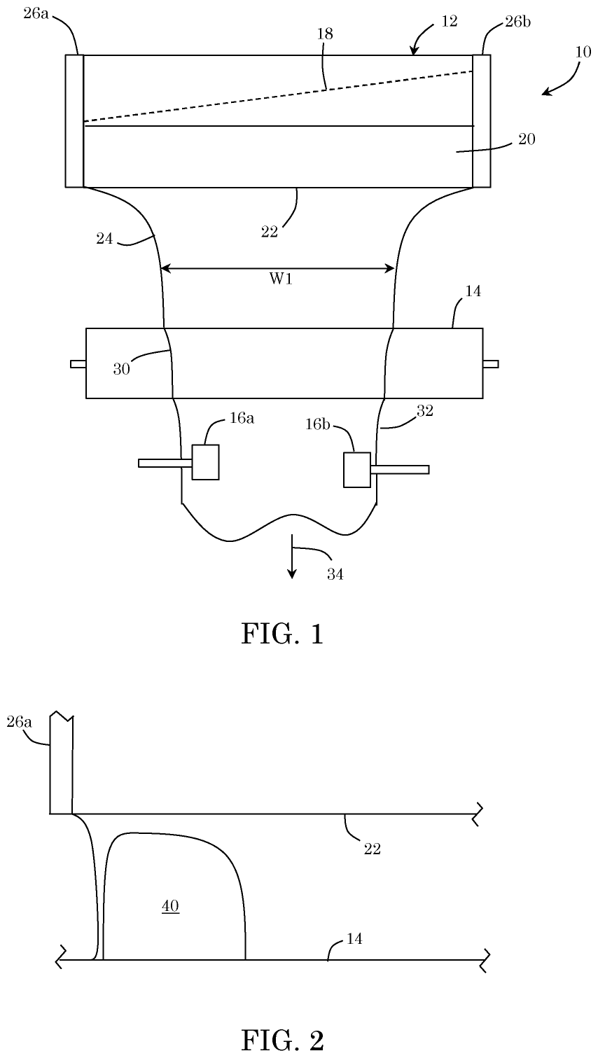

FIG. 1 is a front elevational view of an exemplary apparatus for forming a glass ribbon comprising a forming body 12, a forming roll 14 positioned downstream from the forming body relative to the direction of flow of molten glass from the forming body, and a plurality of pulling rolls 16a, 16b configured to engage with the molten glass ribbon as counterrotating rolls that apply a downward force to the molten glass ribbon.

Forming body 12 comprises a trough 18 disposed in an upper surface of the forming body defined at least in part by a pair of weirs, and a pair of converging forming surfaces 20 positioned below the weirs, the converging forming surfaces meeting at a bottom edge (root) 22 of forming body 12. Molten glass supplied to an inlet end of trough 18 overflows the trough and flows over converging forming surfaces 20 as separate flows of molten glass, the separate flows of molten glass joining at or below root 22 and flowing downward therefrom as a combined stream of molten glass, for example a first molten glass ribbon 24. Dams 26a, 26b positioned at the ends of forming body 12 limit the lateral flow of molten glass and prevent the molten glass from flowing past the forming body ends.

In other aspects, forming body 12 may comprises a slot draw apparatus, wherein a vessel configured to receive a flow of molten glass includes a slot extending across a bottom of the vessel such that molten glass supplied to the interior of the vessel flows from the vessel through the slot. In still other aspects, forming body 12 may include a vessel configured to receive a flow of molten glass and include a distribution pipe that extends from a bottom orifice of the vessel, the distribution pipe including a slotted channel from which the molten glass in the chamber may exit as a molten glass ribbon.

In yet other aspects, the forming body may include a metallic overflow pipe configured to receive a flow of molten glass, the overflow pipe comprising a slot extending across an upper surface of the overflow pipe. Molten glass provided to the overflow pipe fills the overflow pipe, and overflows the overflow pipe through the slot, the molten glass issuing from the slot flowing over opposing sides of the overflow pipe to thereafter join at a bottom of the overflow pipe to form a glass ribbon.

In the apparatus depicted in FIG. 1, first molten glass ribbon 24 is directed onto downstream forming roll 14 as a molten glass layer 30, downstream forming roll 14 rotating in a direction that pulls the molten glass downward, away from root 22. The molten glass layer 30 deposited on forming roll 14 is released from forming roll 14 after rotating along with the forming roll a redetermined portion of a circular arc and is drawn from the forming roll as a second glass ribbon 32 by a first pair of counterrotating pulling rolls 16a and a second pair of counterrotating pulling rolls 16b that engage with the side edge portions of second glass ribbon 32 and draw second glass ribbon from the forming roll in a draw direction 34. Downstream processes (not shown) may be used to separate second glass ribbon 32 into discrete glass sheets of predetermined length. Such discrete glass sheets may then be further processed, for example to remove the edge portions contacted by the pulling rolls, wash the glass sheets, stack the glass sheets, and/or package the glass sheets, etc.

As the molten glass leaves root 22, surface tension and viscous forces cause first molten glass ribbon 24 to contract in a lateral direction (e.g., parallel with root 22). Accordingly, the width W1 of first molten glass ribbon 24 may undergo a significant reduction as a function of distance from root 22, which in turn reduces the width of the commercially useful portion of second glass ribbon 32, thus limiting the size of the glass sheets derived therefrom. Conservation of mass causes edge portions of first glass ribbon to thicken as the first glass ribbon undergoes lateral contraction such that the thickness of the edge portions is greater than a thickness of the first glass ribbon in a central portion of the first glass ribbon inward of the edge portions. Such thickened edge portions are typically detrimental to the commercial value of the ribbon and are subsequently removed, thereby further decreasing the useful width of the second glass ribbon. To increase the commercially useful portion of the second glass ribbon, and subsequent glass sheets produced therefrom, it is desirable to reduce the initial contraction of the first glass ribbon. That is, apparatus and/or methods to reduce lateral contraction of the first glass ribbon can help to increase the width of the subsequent second glass ribbon, for example by controlling the flow of molten glass at the edge portions of the first glass ribbon.

Additionally, flow conditions, e.g., flow rate and distance of fall for first molten glass ribbon 24 from forming body 12 to forming roll 14, can cause the flow of molten glass from the forming body to oscillate. That is, the width of the flow of molten glass may vary over time. Such a fluctuation in flow can disrupt the forming process.

A function of edge directors in a conventional fusion process is to ensure the molten glass wets the end dams at the end of the forming body. In other processes, the converging forming surfaces may have a smaller included angle (e.g., 10-20 degrees), than is typical. A smaller included angle allows the glass to wet the end dam without an edge director filling the corner of the intersection of the end dam and forming body surface. This allows edge directors to be placed below the root of the forming body without being connected to the forming body. However, in the absence of edge directors, voids 40 may appear that separate the single stream into multiple parts (see FIG. 2), which is unacceptable in a production process.

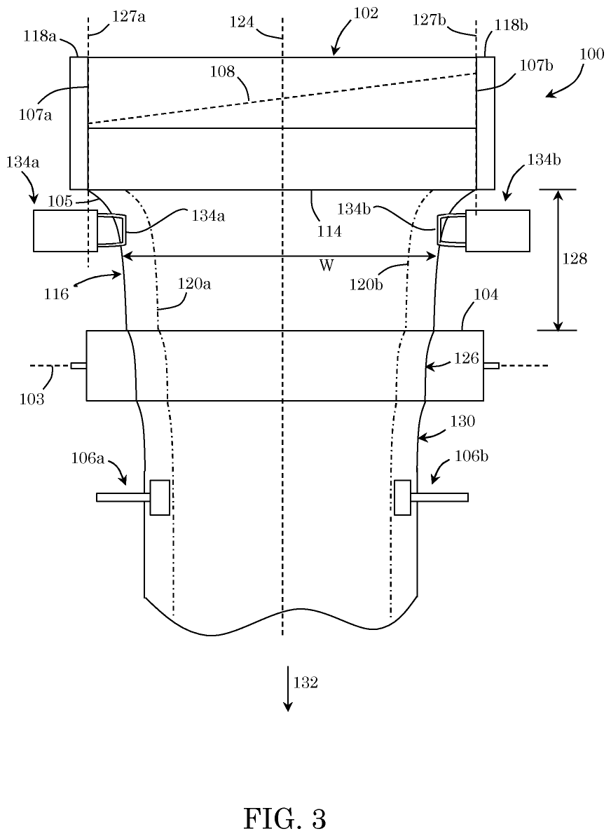

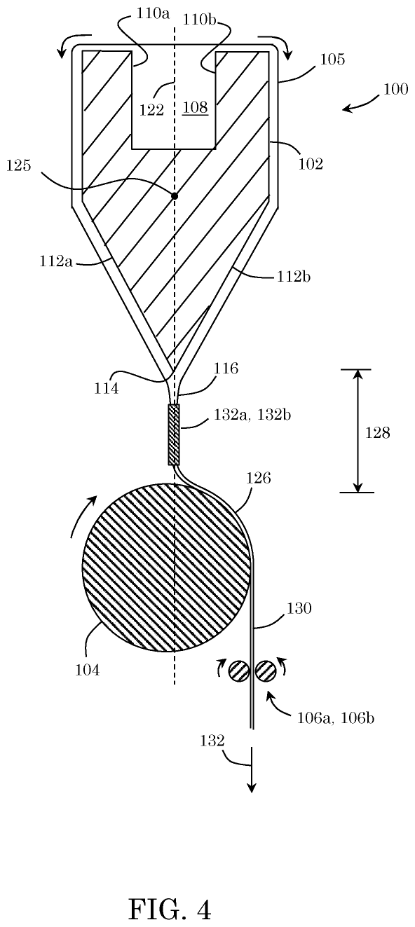

FIGS. 3 and 4 show a front elevational view and a side cross-sectional view, respectively, of an exemplary apparatus 100 for forming a glass ribbon according to the present disclosure. Apparatus 100 comprises a forming body 102, and optionally a forming roll 104 rotatable about axis of rotation 103 and positioned downstream from the forming body relative to a flow of molten glass 105 from the forming body. While forming body 100 is depicted as identical or similar to forming body 12, forming body 102 may be any other suitable forming body, such as other forming bodies described herein (e.g., slotted forming bodies). Forming roll 104 may be a driven forming roll, therein the forming roll is coupled to a motor (not shown) configured to rotate the forming roll about axis of rotation 103. Apparatus 100 may further include a plurality of pulling roll pairs 106a, 106b, e.g., a first pair of counterrotating pulling rolls 106a positioned to engage with a first edge portion of a flow of molten glass drawn from the forming body (or forming roll if a forming roll is used), and a second pair of counterrotating pulling rolls 106b positioned to engage with an opposing second edge portion. In the embodiment of FIGS. 3 and 4, forming body 102 comprises a first end 107a, a second end 107b opposite first end 107a, and a trough 108 disposed in an upper surface of the forming body between first end 107a and second end 107b and defined at least in part by a pair of weirs 110a, 110b. A lower portion of forming body 102 comprises converging forming surfaces 112a, 112b positioned below the weirs on opposite sides of the forming body, converging forming surfaces 112a, 112b meeting at bottom edge (root) 114 of forming body 102. Molten glass 105 supplied to an inlet end of trough 108 overflows weirs 110a, 110b and flows downward over converging forming surfaces 112a, 112b as separate flows of molten glass, the separate flows of molten glass joining at or below root 114 and flowing downward therefrom as a combined stream of molten glass, for example a first ribbon 116 of molten glass. Dams 118a, 118b positioned at the opposing ends of forming body 102 limit the lateral flow of molten glass on the forming body and prevent molten glass 105 from flowing past forming body end 107a, 107b. In the apparatus depicted in FIGS. 2 and 3, at least a portion of the combined flow of molten glass, comprising first edge portion 120a extending along a length of the first molten glass ribbon 116 and second edge portion 120b extending along the length of the first molten glass ribbon 116 opposite from first edge portion 120a, flows along a draw plane 122, shown edge-on in FIG. 3, draw plane 122 extending through and parallel with root 114. Draw plane 122 may be a vertical plane. A first vertical plane 124 orthogonal to draw plane 122, shown edge-on in FIG. 2, can be envisioned to bisect forming body 102. That is, first vertical plane 124 may be midway between first end 107a and second end 107b, and orthogonal to a longitudinal axis 125 extending through the forming body. A second vertical plane 127a extends parallel to first vertical plane 124 and is coincident with first end 107a of the forming body. A third vertical plane 127b extends parallel to first vertical plane 124 and is coincident with second end 107b of the forming body. First molten glass ribbon 116 may, in some embodiments, be subsequently directed onto downstream forming roll 104 as a layer 126 of molten glass, with downstream forming roll 104 rotating in a direction that draws the molten glass downward, away from root 114. Forming roll 104 may be especially useful for glass compositions that exhibit low viscosity at processing temperatures, for example less than about 5,000 Pa·s, and therefore must be further cooled, for example by depositing the low-viscosity molten glass of first molten glass ribbon 116 on a cooled surface, such as forming roll 104. In other embodiments employing different glass compositions, the molten glass issuing from root 114 may have sufficient viscosity, for example equal to or greater than about 5,000 Pas, to omit forming roll 104.

When forming roll 104 is employed, root 114 and forming roll 104 are separated by a predetermined separation distance 128. The layer 126 of molten glass deposited on forming roll 104 is released from the forming roll after rotating along with forming roll 104 over a portion of a circular arc, becoming a second glass ribbon 130 descending from the forming roll after release therefrom. Forming roll 104 may be used, for example, to increase the viscosity of molten glass layer 126 by cooling the molten glass layer. For example, forming roll 104 may be provided with a cooling passage (not shown). The cooling passage may be arranged to receive a flow of coolant, e.g., liquid or gas (such as water or air), to cool a surface of the forming roll to a predetermined temperature. Accordingly, the coolant may be supplied by a chilling system, for example a chilled water system that includes temperature control of the coolant.

Counterrotating pulling roll pairs 106a, 106b positioned below and downstream from forming body 102, for example below and downstream from forming roll 104, engage with first edge portion 120a and second edge portion 120b and draw a glass ribbon, either first molten glass ribbon 116 from root 114 or second glass ribbon 130 from forming roll 104 if forming roll 104 is employed, in draw direction 132. Downstream processes (not shown) may be used to separate the glass ribbon, e.g., second glass ribbon 130, into discrete glass sheets of predetermined length. Such discrete glass sheets may then be further processed, for example to remove the contacted edge portions, grind or polish the glass sheets as necessary, wash the glass sheets, stack the glass sheets, and/or package the glass sheets, etc. Further description will assume forming roll 104 is employed, with the understanding that in further embodiments, forming roll 104 may not be utilized.

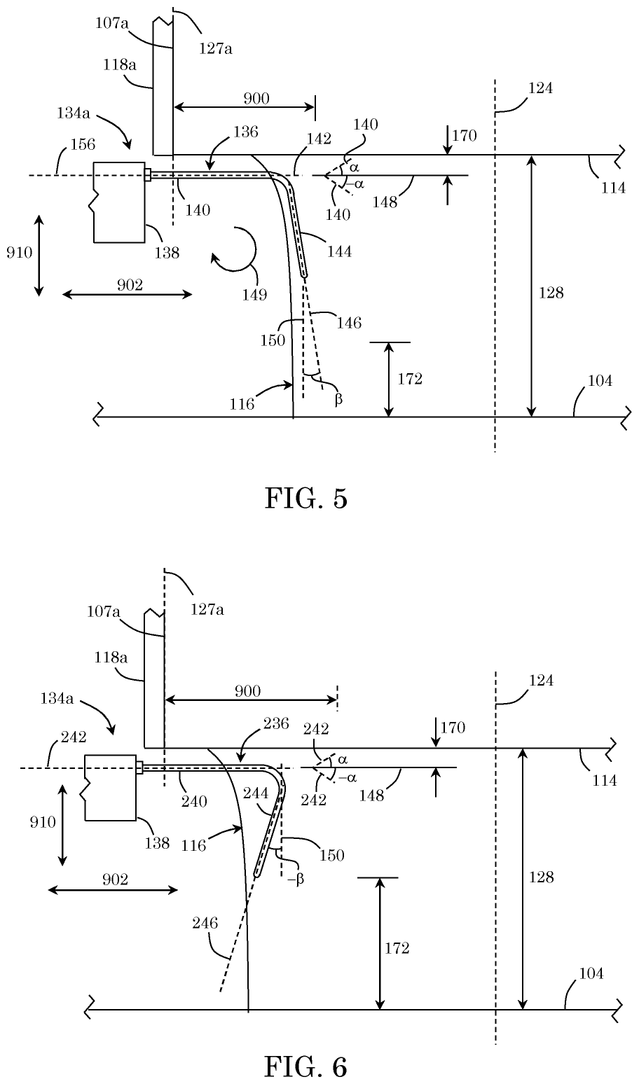

According to embodiments disclosed herein, a pair of edge directors 134a, 134b are positioned below root 114 and arranged to contact with the molten glass of first molten glass ribbon 116. That is, a portion of each edge director 134a, 134b can be extended into the flow of molten glass descending from root 114, and in particular, into the flow of molten glass at first and second edge portions 120a, 120b of first molten glass ribbon 116, and be immersed therein. First and second edge directors 134a and 134b may reduce lateral contraction of first molten glass ribbon 116 that would otherwise reduce the width of the first glass ribbon. Alternatively, or in addition, first and second edge directors 134a and 134b may help stabilize the flow of molten glass from forming body 102. In the absence of edge control and depending on the viscosity of the molten glass and the separation distance 128 between root 114 and forming roll 104, first molten glass ribbon 116 may uncontrollably fluctuate (e.g., oscillate) in width, thereby making process control, and product uniformity, difficult. Edge directors, such as the edge directors disclosed herein, may aid in reducing this oscillation. FIG. 5 is a close-up view of one such edge director (e.g., first edge director 134a) showing the edge director's relationship with forming body 102 and forming roll 104. The following discussion will address first edge director 134a, with the understanding second edge director 134b may be similar or identical to first edge director 134a.

As shown in FIG. 5, first edge director 134a comprises an immersion tool 136. As used herein “immersion tool” refers to a device comprising one or more elongate members, such as one or more wires, that can be extended into the molten glass and may be at least partially immersed in the flow of molten glass from forming body 102, i.e., first molten glass ribbon 116. At least a portion of immersion tool 136 can be positioned between first vertical plane 124 and First edge director 134a may further comprise a housing 138 configured to support immersion tool 136, and, if needed, movement of the immersion tool relative to the forming body (e.g., the flow of molten glass from root 114).

In the embodiment of FIG. 5, the illustrated immersion tool 136 comprises two tool segments, a first tool segment 140 extending along a first longitudinal axis 142 and a second tool segment 144 extending along a second longitudinal axis 146. First tool segment 140 and second tool segment 144 are configured as a continuous member, meaning second tool segment 144 is connected to first tool segment 140 and extends therefrom. However, first and second tool segments 140, 144 need not be homogeneous (e.g., formed continuously as one piece). For example, second tool segment 144 may be joined to first tool segment 140, such as by welding or brazing. First longitudinal axis 142 forms an angle α relative to a horizontal axis 148 intersecting first longitudinal axis 142. Root 114 may be parallel with horizontal axis 148. Accordingly, horizontal axis 148 may be coincident with root 114. The angle α may be positive, negative, or zero. A positive angle α denotes an upward slope to first longitudinal axis 142 relative to horizontal axis 148 (going from left to right in FIG. 5, in a direction toward first vertical plane 124), while a negative angle α denotes a downward slope to first longitudinal axis 142 relative to horizontal axis 148. A zero angle α denotes first longitudinal axis 142 is horizontal (i.e., parallel with horizontal axis 148). Slopes described herein are evaluated in a clockwise direction from the first tool segment to the last tool segment (see arrow 149).

Second tool segment 144 extends downward from first tool segment 140 along second longitudinal axis 146. Second longitudinal axis 146 forms an angle β relative to a vertical axis 150 intersecting second longitudinal axis 146. The angle β may be positive, negative, or zero. A positive angle β relative to vertical axis 150 denotes second longitudinal axis 146, and second tool segment 144, extend downward in a direction toward first vertical plane 124 (to the right in FIG. 4), while a negative angle α denotes second longitudinal axis 146, and second tool segment 144, extend downward in a direction away from first vertical plane 124 (to the left in FIG. 5). A zero angle β denotes second longitudinal axis 146, and second tool segment 144, extend vertically downward from first tool segment 140 (i.e., parallel with vertical axis 150).

FIG. 6 illustrates first edge director 134a with another exemplary immersion tool 236 comprising a first tool segment 240 extending along a first longitudinal axis 242 and a second tool segment 244 extending along a second longitudinal axis 246. First tool segment 240 and second tool segment 244 are configured as a continuous member. While first tool segment 240 is shown as identical to first tool segment 140 of FIG. 5 and forms an angle α with horizontal axis 148, second longitudinal axis 246, and second tool segment 244, are depicted as extending downward from first tool segment 240 at a negative angle β relative to vertical axis 150 intersecting second longitudinal axis 246, away from first vertical plane 124.

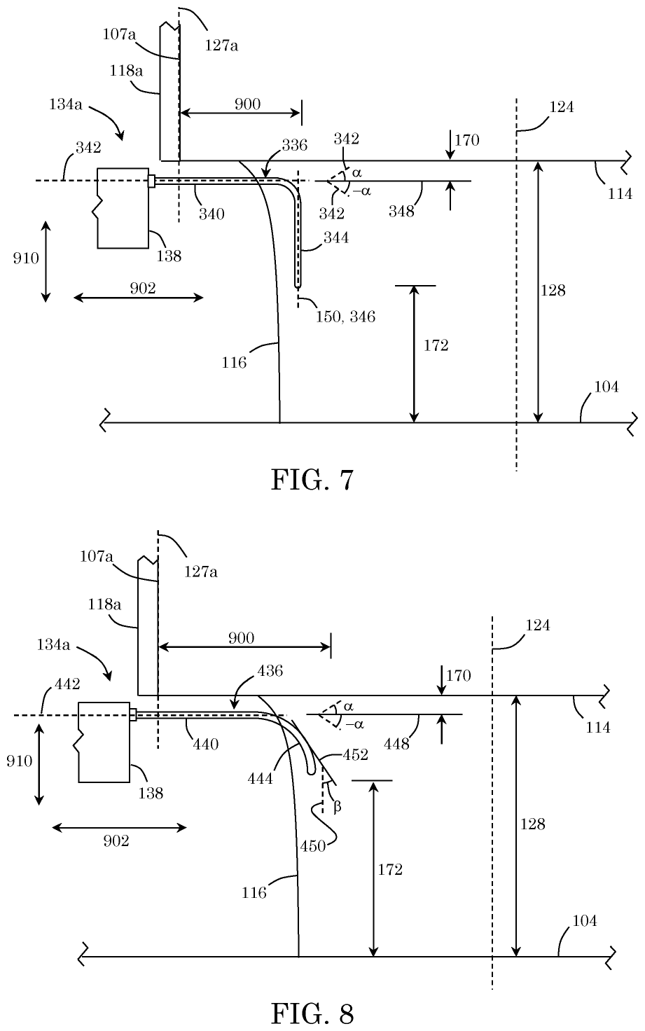

FIG. 7 illustrates first edge director 134a comprising still another exemplary immersion tool 336 comprising a first tool segment 340 extending along a first longitudinal axis 342, and a second tool segment 344 extending along a second longitudinal axis 346. First tool segment 340 and second tool segment 344 are configured as a continuous member. As shown, first tool segment 340 may be identical to the first tool segment 140 of FIG. 5 or first tool segment 240 of FIG. 6. However, second longitudinal axis 346, and second tool segment 344, are depicted as extending vertically downward from first tool segment 340 (i.e., at a zero angle β, parallel to vertical axis 150 and first vertical plane 124).

FIG. 8 illustrates first edge director 134a comprising another exemplary immersion tool 436 wherein at least a portion of immersion tool 436 extends downward. Immersion tool 436 of FIG. 8 comprises a first tool segment 440 extending inward along first longitudinal axis 442, toward first vertical plane 124, as depicted in FIGS. 5-7. However, instead of being linear, second tool segment 444 of immersion tool 436 is shown as curved, e.g., comprising a portion of an arc. In this instance, the angle of the curve can be determined from a tangent line to the convex curvature of the arc (e.g., the “outside” of the arc) relative to vertical axis 450 intersecting the tangent line. In the example depicted in FIG. 8, the tangent line 452 extends downward at a positive angle β relative to vertical axis 450. Any one or more segments of the immersion tools disclosed herein may include curved portions, in whole or in part.

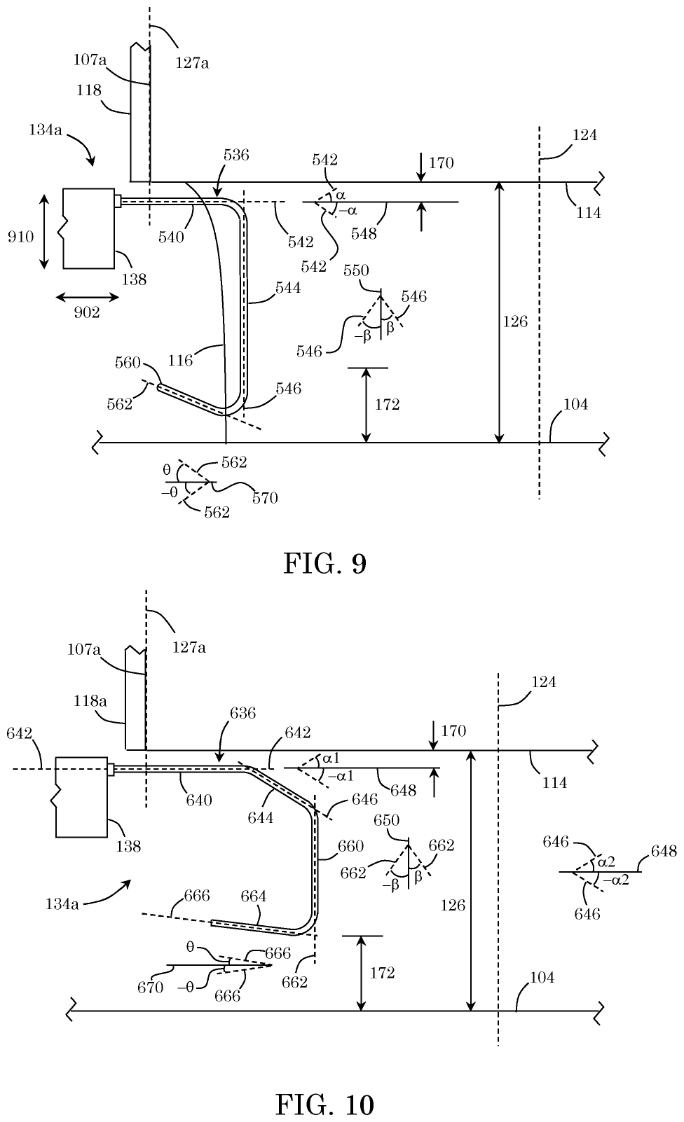

FIG. 9 illustrates first edge director 134a comprising yet another exemplary immersion tool 536 comprising three tool segments, a first tool segment 540 extending along a first longitudinal axis 542, a second tool segment 544 extending along a second longitudinal axis 546, and a third tool segment 560 extending along a third longitudinal axis 562. First longitudinal axis 542 extends inward from housing 138, toward first vertical plane 124 at angle α relative to horizontal axis 548 intersecting first longitudinal axis 542. As previously described, angle α may be positive, negative, or zero relative to a horizontal axis (e.g., horizontal axis 548). Second longitudinal axis 546, and second tool segment 544, extend downward from first tool segment 540 at angle β relative to vertical axis 550 intersecting second longitudinal axis 546. Angle β may be positive, negative, or zero. Third longitudinal axis 562, and third tool segment 560, extend from second tool segment 544 to the left, away from first vertical plane 124 at an angle θ relative to a horizontal axis, e.g., horizontal axis 570 intersecting third longitudinal axis 562. Angle θ may be positive, negative, or zero. A positive angle θ denotes third longitudinal axis 562, and third tool segment 560, slope upward from second tool segment 544 relative to horizontal axis 570. A negative angle θ denotes third longitudinal axis 562, and third tool segment 560, slope downward from second tool segment 544 relative to horizontal axis 570. A zero angle θ denotes third longitudinal axis 562, and third tool segment 560, extend horizontally from second tool segment 544.

FIG. 10 illustrates first edge director 134a comprising another exemplary immersion tool 636 comprising four tool segments, a first tool segment 640 extending along a first longitudinal axis 642, a second tool segment 644 extending from first tool segment 640 along a second longitudinal axis 646, a third tool segment 660 extending from second tool segment 644 along a third longitudinal axis 662, and a fourth tool segment 664 extending from third tool segment along a fourth longitudinal axis 666. First longitudinal axis 642, and first tool segment 640, extend inward from housing 138, toward first vertical plane 124, at angle α1 relative to horizontal axis 648 intersecting first longitudinal axis 642. Root 114 may be parallel with horizontal axis 648. Horizontal axis 648 may be coincident with root 114. Angle α1, may be positive, negative, or zero. A positive angle α1 denotes first longitudinal axis 642, and first tool segment 640, slope upward relative to horizontal axis 648. A negative angle α1 denotes first longitudinal axis 642, and first tool segment 640, slope downward relative to horizontal axis 648. A zero angle α1 denotes first tool segment 640 extends horizontally.

Second longitudinal axis 646, and second tool segment 644, extend inward from first tool segment 640, toward first vertical plane 124 at angle α2 relative to horizontal axis 648 intersecting second longitudinal axis 646. A positive angle α2 denotes second longitudinal axis 646, and second tool segment 644, slope upward relative to horizontal axis 648. A negative angle α2 denotes second longitudinal axis 646, and second tool segment 644, slope downward relative to horizontal axis 648. A zero angle α2 denotes second tool segment 644 extends horizontally from first tool segment 640.

Third longitudinal axis 662, and third tool segment 660, extend downward from second tool segment 644 at angle β relative to vertical axis 670. The angle β may be positive, negative, or zero. A positive angle β relative to vertical axis 650 intersecting third longitudinal axis 662 denotes third longitudinal axis 662, and third tool segment 660, extend downward in a direction toward first vertical plane 124 (to the right in FIG. 10), while a negative angle β denotes third longitudinal axis 662, and third tool segment 660, extend downward in a direction away from first vertical plane 124 (to the left in FIG. 10). A zero angle β denotes third longitudinal axis 662, and third tool segment 660, extend vertically downward from second tool segment 644 (i.e., parallel with vertical axis 650).

Fourth longitudinal axis 666, and fourth tool segment 664, extend outward from third tool segment 660, away from first vertical plane 124 at an angle θ relative to horizontal axis 670 intersecting fourth longitudinal axis 666. A positive angle θ denotes fourth longitudinal axis 666, and fourth tool segment 664, slope upward relative to horizontal axis 670. A negative angle θ denotes fourth longitudinal axis 666, and fourth tool segment 664, slope downward relative to horizontal axis 670. A zero angle θ denotes fourth tool segment 664 extends horizontally, parallel with horizontal axis 670.

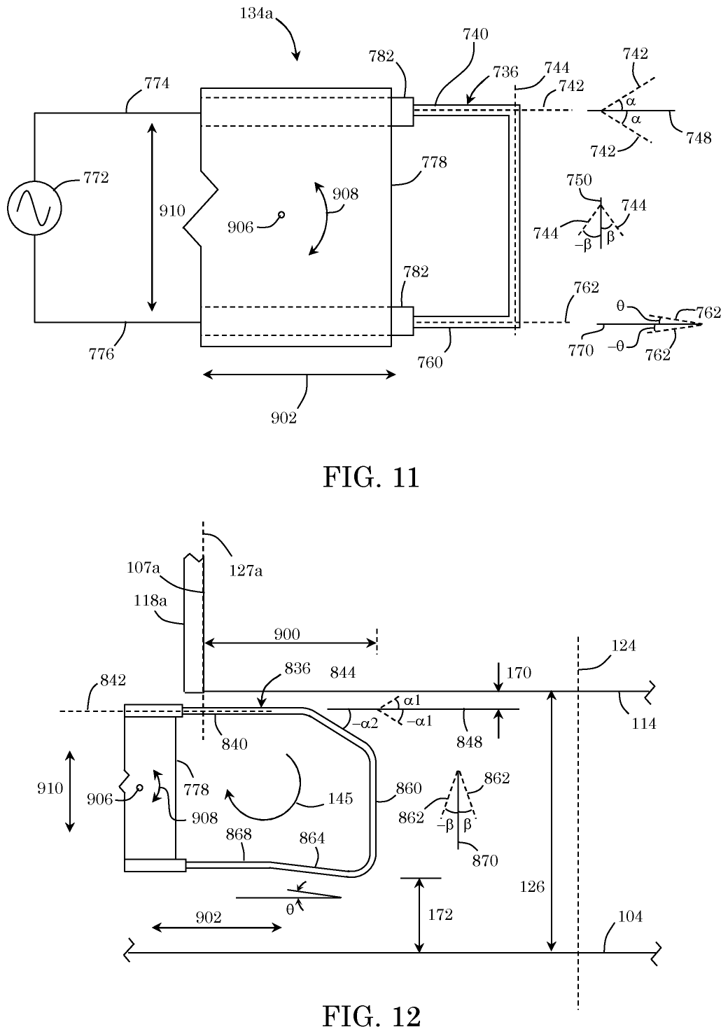

While the exemplary immersion tools of FIGS. 5-10 were supported by their respective housings 138 at one end of the immersion tool (e.g., first tool segments 140, 240, 340, and 440, 540, and 640, respectively), in the embodiment of FIG. 11, immersion tool 736 is in electrical communication with an electrical power supply configured to direct an electrical current through the immersion tool. The immersion tool 736 of FIG. 11 comprises a first tool segment 740 extending along a first longitudinal axis 742 at a first angle α relative to horizontal axis 748 intersecting first longitudinal axis 742. Angle α may be positive, negative, or zero. A second tool segment 744 extends from first tool segment 740 along a second longitudinal axis 746 at a second angle β relative to vertical axis 750 intersecting second longitudinal axis 746. Angle β may be positive, negative, or zero. A third tool segment 760 extends along a third longitudinal axis 762 at an angle θ relative to horizontal axis 770 intersecting third longitudinal axis 762. Angle θ may be positive, negative, or zero. Accordingly, first tool segment 740 and third tool segment 760 represent ends of the immersion tool. These ends are connected to electrical power supply 772 through electrical conductor lines 774 and 776. First tool segment 740 and third tool segment 760 may be in contact with and/or supported by an electrical isolating member 778. Electrical isolating member 778 may comprise housing 138. For example, at least a portion of first tool segment 740 and at least a portion of third tool segment 768 may be embedded in and extend through electrical isolating member 778. While electrical isolating member 778 may be formed from a variety of materials, the position of first edge director 134a close to the flowing molten glass, which may in some instances be in excess of 1000° C., means electrical isolating member 778 may be formed of a heat resistant electrical isolating material. For example, electrical isolating member 778 may be formed of a refractory (e.g., ceramic) material. In some embodiments, first and third tool segments 740, 760 may be positioned on opposite edges of the electrical isolating member 778, for example, adjacent opposing edge surfaces of the electrical isolating member (e.g., an upper edge surface and a lower edge surface. See for example, FIG. 12). However, as shown in FIG. 11, first and third tool segments 740 and 760 may be embedded within electrical isolating member 778. In this latter embodiment, first and third tool segments 740, 760 may be better protected from inadvertent contact with each other or with apparatus that may be positioned close to the edge directors, thereby preventing electrical shorting and electrocution hazards. In some embodiments, a portion of first tool segment 740 and a portion of third tool segment 760, for example end portions, may be formed with a larger cross-sectional diameter than the remainder of the first and third tool segments to provide improved contact with, and/or support by, electrical isolating member 778. However, in embodiments, the end portions of first and third tool segments 740 and 760 may be sleeved, for example with a ceramic material 782. The electrical power supply may include a controller (not shown) configured to control the magnitude of the electrical current directed through the immersion tool and therefore the temperature of the immersion tool as the immersion tool is heated by the electrical current.

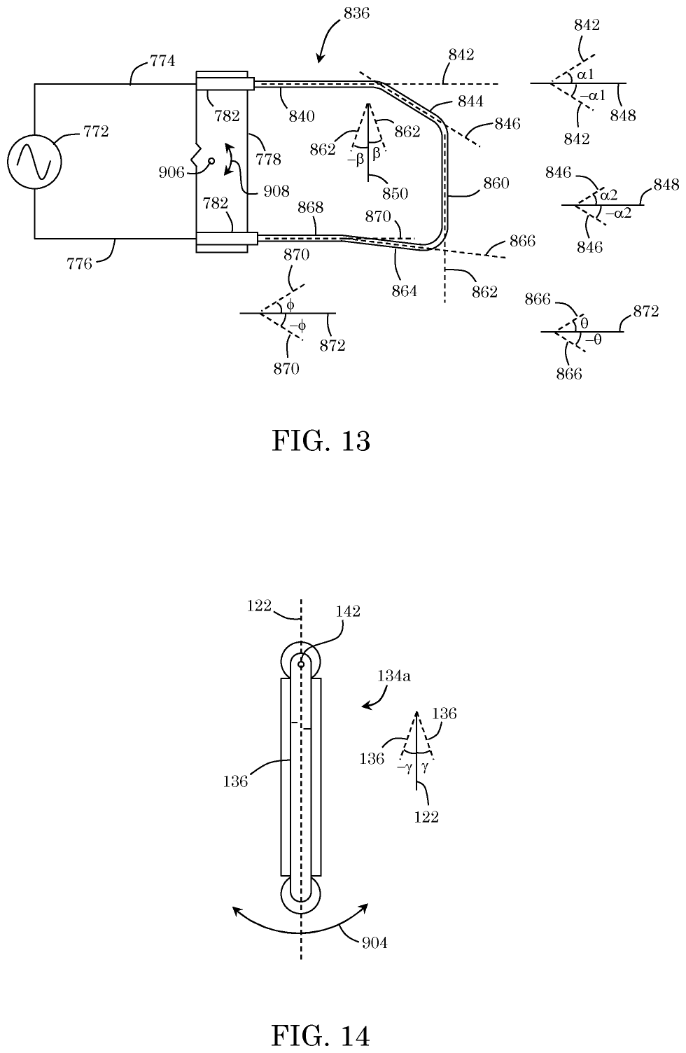

FIGS. 12 and 13 illustrate another exemplary immersion tool 836 comprising a first tool segment 840 extending along a first longitudinal axis 842, a second tool segment 844 extending from first tool segment 840 along a second longitudinal axis 846, a third tool segment 860 extending from second tool segment 844 along a third longitudinal axis 862, a fourth tool segment 864 extending from third tool segment 860 along a fourth longitudinal axis 866, and a fifth tool segment 868 extending from fourth tool segment 864 along a fifth longitudinal axis 870. First tool segment 840, second tool segment 844, third tool segment 860, fourth tool segment 864, and fifth tool segment 868 are configured as a continuous member, e.g., a length of wire comprising a plurality of bends to form a predetermined shape. The embodiment of FIGS. 12 and 13 is similar to the embodiment shown in FIG. 10. For example, first longitudinal axis 842 forms an angle α1 with a horizontal axis 848 intersecting first longitudinal axis 842. Angle α1 can be positive, negative or zero. A positive angle α1 means first longitudinal axis 842 slopes upward relative to horizontal axis 848, a negative angle α1 means first longitudinal axis 842 slopes downward relative to horizontal axis 848, and a zero angle α1 means first longitudinal axis 842 is horizontal. Similarly, second longitudinal axis 846 forms an angle 2 with horizontal axis 848 intersecting second longitudinal axis 846. Angle α2 can be positive, negative or zero. A positive angle α2 means second longitudinal axis 846 slopes upward relative to horizontal axis 848, a negative angle α2 means second longitudinal axis 846 slopes downward relative to horizontal axis 848, and a zero angle α2 means second longitudinal axis 842 is horizontal. Third longitudinal axis 862 forms an angle β with a vertical axis 850 intersecting third longitudinal axis 862. Angle β can be positive, negative or zero. A positive angle β means third longitudinal axis 862 slopes toward first vertical plane 124 (to the right in FIG. 13), a negative angle β means third longitudinal axis 862 slopes away from first vertical plane 124 (to the left in FIG. 13), and a zero angle β means third longitudinal axis 842 is vertical. Fourth longitudinal axis 866 forms an angle θ with horizontal axis 872 intersecting fourth longitudinal axis 866. Angle β can be positive, negative or zero. A positive angle θ means fourth longitudinal axis 866 slopes upward relative to horizontal axis 872, a negative angle β means fourth longitudinal axis 866 slopes downward relative to horizontal axis 872, and a zero angle β means fourth longitudinal axis 866 is horizontal. Fifth longitudinal axis 870 forms an angle ϕ with horizontal axis 872 intersecting fifth longitudinal axis 870. Angle ϕ can be positive, negative or zero. A positive angle ϕ means fifth longitudinal axis 870 slopes upward relative to horizontal axis 872, a negative angle β means fifth longitudinal axis 870 slopes downward relative to horizontal axis 872, and a zero angle β means fifth longitudinal axis 870 is horizontal

A wire immersion tool 136, 236, 336, 436, 536, 636, 736, 836, or any other wire immersion tool, may have a maximum wire diameter equal to or less than about 10 millimeters (mm), for example equal to or less than about 9 mm, equal to or less than about 8 mm, equal to or less than about 7 mm, equal to or less than about 6 mm, equal to or less than about 5 mm, equal to or less than about 4 mm, equal to or less than about 3 mm, equal to or less than about 2 mm, such as in a range from about 1 mm to about 3 mm. An immersion tool 136, 236, 336, 436, 536, 636, 736, 836, and/or any other configuration of wire immersion tool may have a variety of wire cross-sectional shapes in a plane orthogonal to a respective longitudinal axis of particular portions of the immersion tool. The immersion tool, or portions thereof, for example the wire of the immersion tool, may have a circular cross-sectional shape, an elliptical cross-sectional shape, or a polygonal shape (e.g., square, rectangular, hexagonal, octagonal, etc.). Neither the diameter nor the cross-sectional shape of the immersion tool wire need be uniform and may therefore vary along a length of the wire.

The immersion tool 136, 236, 336, 436, 536, 636, 736, 836, and/or any other configuration of wire immersion tool may comprise an electrically conductive material. For example, in some embodiments, the immersion tool may comprise a platinum group metal (i.e., at least one of ruthenium, rhodium, palladium, osmium, iridium, or platinum). In some embodiments, a platinum alloy such as a platinum-rhodium alloy may be used. Platinum-rhodium alloys may include platinum in an amount by weight of about 70% to about 90% and rhodium in an amount by weight of about 30% to about 10%. However, other high temperature metals may be used where appropriate (depending, for example, on the temperature of the molten glass at the first molten glass ribbon), including, but not limited to, molybdenum, tungsten, titanium, tantalum, nickel, and alloys thereof, to name a few. Other suitable materials may include stainless steel or an iron-chromium-aluminum alloy, e.g., Kanthal. In some embodiments, the wire may be formed using a metallic alloy, such as an intermetallic material, for example molybdenum disilicide (MoSi₂) or Ti₃Al.

At least a portion of an immersion tool may be positioned between first vertical plane 124 and second vertical plane 127a (or third vertical plane 127b). One or more portions of an immersion tool may be fully or partially immersed in the molten glass (e.g., edge portion 120a or edge portion 120b) depending on the immersion depth of the respective edge director. That is, the distance by which the immersion tool extends into the molten glass. One way to determine the immersion depth of any of the several embodiments disclosed herein is to measure the distance 900 between dam the first end 127a and the farthest extent of the immersion tool from the first end (or another reference location if needed). While this measure doesn't give a direct means of determining the length an immersion tool immersed in the molten glass, it does provide a convenient, measurable indication of the lateral position of the immersion tool by using, for example, a visual scale to compare with a known reference point. Of course, other reference points may be used to determine the position of the immersion tool relative to the reference location.

First edge director 134a may be configured to have several degrees of freedom of motion. Referring to FIG. 11 as an example, first edge director 134a may be movable in a direction along an axis parallel to root 114, e.g., horizontal axis 148, to vary the immersion depth of first immersion tool 136 (or any other immersion too disclosed herein). That is, the distance by which, by lateral motion parallel to the root, the immersion tool can be inserted into the flow of molten glass at the edge portions of first molten glass ribbon 116. In some embodiments, first edge director 134a may be configured as a removable cartridge so that, should it be necessary to remove the edge director, for example to replace the edge director during operation of the glass forming apparatus with another edge director with different geometry, removal and replacement can be easily accomplished.

As illustrated by FIG. 14, first edge director 134a may be further configured to be rotatable about an axis of the immersion tool. Typically, the immersion tool lies in a plane, e.g., a vertical plane. However, as shown in the figures, first tool segments 140, 240, 340, 440, 540, 640, 740, and 840 each may comprise a longitudinal axis extending along at least a portion of the length of the first tool segment, for example a horizontal first longitudinal axis. Accordingly, the immersion tool 136, 236, 336, 436, 536, 636, 736, and/or 836, or any other configuration of immersion tool, may be configured to rotate about its respective first longitudinal axis 142, 242, 342, 442, 542, 642, 742, or 842. For example, FIG. 14 shows immersion tool 136 rotatable about first longitudinal axis 142 through an angle of ty relative to draw plane 122 as indicated by double headed arc 902 showing rotation of the immersion tool such that portions of the immersion tool can swing out of draw plane 122 while at least a portion of the immersion tool is maintained in the draw plane. It should be apparent that the upper portion of the immersion tool will remain in draw plane 122, while the remainder of the immersion tool will extend out of the draw plane. The extent to which the immersion tool is rotated will dictate how much of the immersion tool remains immersed in the edge portion of the first molten glass ribbon.

First edge director 134a may be further configured to rotate about an axis 904 orthogonal to draw plane 122. See for example, FIG. 13, wherein first edge director 134a, and therefore immersion tool 836, is configured to rotate about axis 904, as indicated by double-headed arc 906. First edge director 134a may be configured to move in a vertical direction, as indicated by double-headed arrow 908 (see, for example, FIG. 12). For example, first edge director 134a may be coupled to an actuator configured to move first edge director 134a vertically, either up (in a direction opposite the flow direction of molten glass from the forming body), or down, in a direction with the flow direction of molten glass from the forming body).

There are many process variables that may affect the flow characteristics of molten glass during the forming process, including chemical composition, temperature, viscosity, flow rate, rotation rate of the forming roll, distance of the forming roll from the root, etc., wherein some or all of variables may be interdependent. Accordingly, the shape and size of the immersion tool can be varied to obtain the desired mitigation of lateral contraction dependent on those and other process variables. As an example, immersion tool 136 of FIG. 5 was previously described as having two segments having varied angles relative to a horizontal and/or a vertical axis. Thus, for example, any one or more of angles α, β, and/or lengths of the immersion tool segments may be varied to obtain the desired mitigation of lateral contraction and/or ribbon stability. Moreover, various segments may be added or removed from the immersion tool. For example, the immersion tool of FIG. 12 comprises a more complex shape with more segments than the immersion tool depicted in FIG. 11.

The viscosity of the molten glass in contact with the immersion tool can be varied by establishing an electrical current in the immersion tool, via electrical power supply 772 and suitable wiring (e.g., electrical leads 774, 776) such that the temperature of molten glass in contact with the immersion tool can be increased or decreased, depending on the magnitude of the electrical current, thereby altering the flow characteristics of the molten glass in contact with the immersion tool. Heating of the immersion tool may also prevent devitrification of molten glass in contact with surfaces of the immersion tool by maintaining a temperature of the molten glass in contact with the immersion tool above the liquidus temperature of the molten glass.

It should also be apparent that the location of first edge director 134a relative to root 114 and forming roll 104 can be used to control flow characteristics of the edge portions of first molten glass ribbon 116. That is, in embodiments, the first distance 170 of the upper-most segment of the immersion tool from root 114 and the second distance 172 of the lower-most segment of the immersion tool from forming roll 104 may play a role in the performance of first edge director 134a in mitigating lateral contraction of first molten glass ribbon 116. Accordingly, in embodiments, first edge director 134a may be configured such that the vertical position of the edge director, and particularly the vertical position of the immersion tool relative to root 114 and/or forming roll 104, can be varied. Any one or more of the foregoing degrees of freedom of motion may be used, either individually or together, in whole or in part, to control the flow of molten glass in first molten glass ribbon 116, and in particular, the edge portions. A horizontal position of first edge director 134a relative to and end of the forming body, e.g., dam 118a, may be variable. That is, first edge director 134a, and therefore the immersion tool, may be moved inward, parallel to draw plane 122 and toward first vertical plane 124, or outward, parallel to draw plane 122 and away from first vertical plane 124. For example, the first edge director 134a may be coupled to an actuator configured to move the first edge director toward first vertical plane 124, or outward, away from first vertical plane 124. Alternatively, first edge director 134a may be manually moveable, for example attached to a fixture that allows translation along an axis parallel to draw plane 122. First edge director may be locked into any desirable position along that axis.

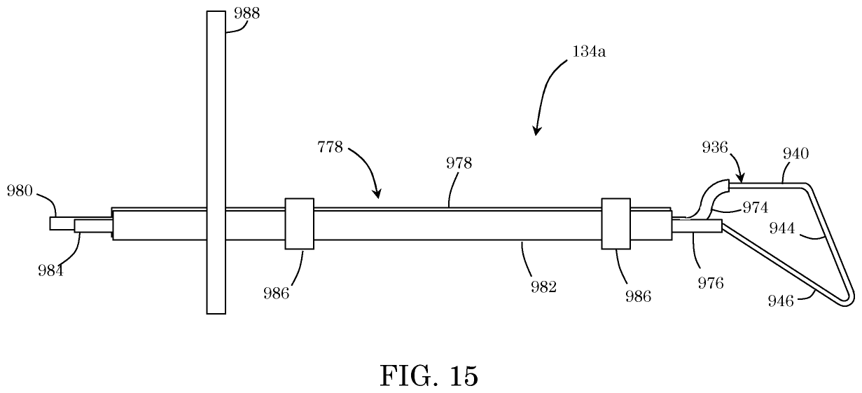

FIG. 15 illustrates yet another first edge director 134a. The edge director of FIG. 15 comprises an immersion tool 936 comprising a first tool segment 940, a second tool segment 944 extending from first tool segment 940, and a third tool segment 946 extending from second tool segment 944. First tool segment 940 is joined to or extends from a first thickened wire section 974 while third tool segment 946 is joined to or extends from a second thickened wire section 976. First and/or second thickened wire sections 974 and/or 976 may be formed, for example, by welding, brazing, or otherwise joining two or more wires together to form a wire having a greater thickness (e.g., diameter) than first and third tool segments 940 or 946. For example, first thickened wire section 974 may include an extension of first tool segment 940 to which one or more additional lengths of wire may be joined, thereby creating a thickened length of wire with reduced electrical conductivity compared to the thinner portion of the first tool segment. Similarly, second thickened wire section 976 may include an extension of third tool segment 946 to which one or more additional lengths of wire may be joined, thereby creating a thickened length of wire with reduced electrical conductivity compared to the thinner portion of the third tool segment. First and second thickened wire sections 974 and/or 976 may be housed by electrical isolating member 778. For example, electrical isolating member 778 may comprise a first refractory member 978, e.g., a tubular refractory member, comprising a first bore extending through the length of the first refractory member, wherein first thickened wire section 974 extends through the first bore and may be connected at first end 980 with electrical power supply 772 through electrical leads 774, 776 (not shown). Similarly, electrical isolating member 778 may comprise a second refractory member 982, e.g., a tubular refractory member, comprising a second bore extending through the length of the second refractory member, wherein second thickened wire section 976 extends through the second bore and may be connected at second end 984 with electrical power supply 772. First refractory member 978 may be coupled to second refractory member 982 by one or more coupling members 986. The one or more coupling members 986 may be, for example clamps, ties, additional refractory bodies including one or more bores through which first and second refractory members 978, 982 may be passed, or any other device suitable to couple first refractory member 978 to second refractory member 982. First and second refractory members 978, 982 provide rigidity to first and second thickened wire sections 974, 976 to support the weight of molten glass that may accumulate on the immersion tool while the immersion tool is immersed in the flow of molten glass (first molten glass ribbon), and further provide electrical isolation between the first and second thickened wire sections. First and second refractory members 978, 982 may be formed of alumina, although other high temperature, electrical isolating material may be used. In some embodiments, a single refractory member may be used comprising two bores, one bore for each of the two thickened wire sections. First and second refractory members 978, 982 may be further supported by a suitable support member 988. Support member 988 may include functionality to provide the earlier-described degrees of freedom of movement to the edge director. That is, support member 988 may be configured to provide vertical movement, horizontal movement, and/or rotational movement to first edge director 134a. Such movement may be facilitated by one or more actuators coupled to the first edge director, or movement may be accomplished by hand.

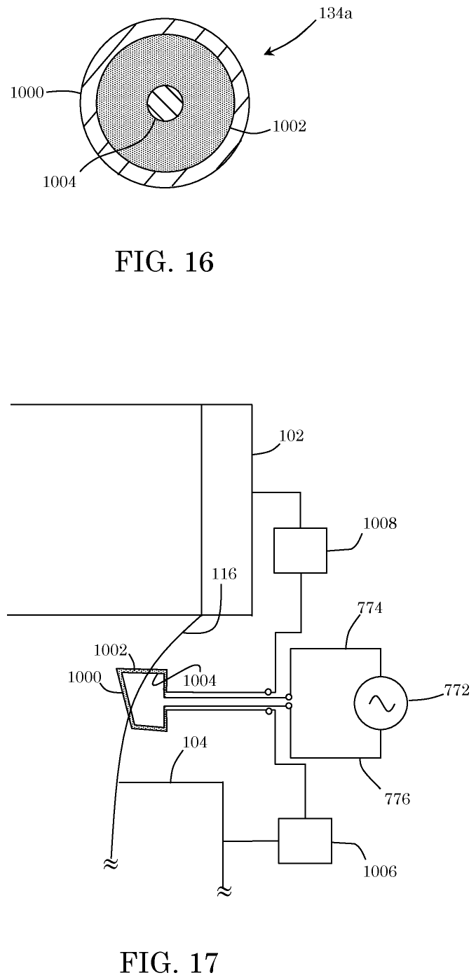

It should be readily apparent that a variety of immersion tool configurations may be utilized as edge directing apparatus inserted into first molten glass ribbon 116 downstream and spaced apart from root 114 of the forming body. Molten glass wets the immersion tool wire and follows the downward path of the wire. Once the molten glass separates from the wire, the glass ribbon attenuates until its viscosity becomes too high or it contacts the forming roll, if present. The wire can be extended downward as far as necessary to reduce the distance the molten glass ribbon is unsupported and attenuating. Referring now to FIG. 16, in aspects of the disclosure, including at least all aspects and embodiments disclosed herein where the immersion tool is configured to conduct an electrical current, thereby heating the immersion tool, the immersion tool may comprise an external sheath 1000 and an electrically isolating layer 1002 disposed between the central wire of the immersion tool and external sheath 1000. Since the wire immersion tool is positioned in the flow of molten glass descending from the forming body, the wire will need to have sufficient rigidity (e.g., thickness, diameter) to resist deformation due to the force of the flow. As the diameter of the wire increases, the electrical resistance of the wire decreases, thereby requiring an increase in electrical current to heat the wire to a sufficient temperature. Accordingly, in aspects, an external electrically conductive sheath 1000 may be added to provide rigidity without the need to increase the diameter of the wire to obtain the desired heating capacity. For example, sheath 1000 may comprise platinum, e.g., platinum in an amount from 70% to 90% by weight and rhodium in an amount from about 10% to about 30% by weight. However, other high temperature metals may be used where appropriate (depending, for example, on the temperature of the molten glass at the first molten glass ribbon), including, but not limited to, molybdenum, tungsten, titanium, tantalum, nickel, and alloys thereof, to name a few. Sheath 1000 may be, for example, a tube disposed about the wire immersion tool. A cross-section of a portion of an immersion tool 1004 is shown in FIG. 16. Electrically isolating layer 1002 should be a non-electrical conducting material capable of resisting degradation due to the high temperature imposed by the molten glass in contact with the immersion tool. For example, electrical isolating layer 1002 may comprise alumina. The electrically isolating layer isolates the immersion tool from contact with the molten glass

Since the molten glass flowing through the glass making apparatus is mildly conductive, it has been found that electrical currents imposed on components of the glass making apparatus, e.g., in the melting vessel (used to melt the batch materials), and on the various metallic conduits and vessels that may be directly heated by establishing an electrical current therethrough, can lead to stray electrical currents in downstream components of the process. For example, forming body 102 and forming roll 104 may become electrical circuit elements. These stray electrical currents can cause disruptions in the adhesion of the molten glass to forming roll 104 and/or produce blisters (bubbles) at surfaces of forming body 102 and/or forming roll 104.

In some embodiments, a DC bias voltage may be established between sheath 1000 and forming roll 104 to control adhesion of the molten glass to the forming roll surface. For example, referring now to FIG. 17, a first DC power supply 1006 may be in electrical communication with, for example connected with and between sheath 1000 and forming roll 104. The polarity and magnitude of the first voltage V1 provided by first DC power supply 1006 can be selected using a suitable controller (not shown) as needed to control adhesion. By way of example, first voltage V1 may be controlled within a range from about −3 volts DC to about +3 volts DC, such as in a range from about −2 volts DC to about +2 volts DC, with a second electrical current in a range from about 0 to about 5 amps. Such an arrangement is shown in FIG. 17, using immersion tool 936 for illustration and not limitation.

To mitigate against the formation of blisters at surfaces of forming body 102 in contact with the molten glass, a second DC power supply 1008 may be connected with and between forming body 100 and sheath 1000. This is particularly effective if forming body 102 is a metallic forming body. A second voltage V2 and a second electrical current provided by second DC power supply 1008 may fall within the same magnitudes as those provided by first DC power supply 1006, although the polarity may differ.

Sufficient flow should be available on the immersion tool and across the ribbon to allow a continuous ribbon to be obtained. Otherwise, voids may develop in the ribbon and advance upstream to the root of the forming body, wherein the molten glass ribbon may break into streams similar to that shown in FIG. 2. As flow rate at the edges of the molten glass ribbon is increased, the hole closes, but the edge flow may become unstable by a mechanism similar to dripping. As the flow is increased further, the flow at the edges can stabilize. However, high flow rates may be impractical for production. Thus, lower flows at the edges of the molten glass ribbon can be beneficial to the process if stabilized with edge directors. Edge directors described herein can function to collect enough flow at the immersion tool that the ribbon edge is stable when it leaves the immersion tool. Greater flow at the edges of the molten glass ribbon may allow wire edge directors that have a vertical wire very near the dams to maintain ribbon width very close to the root length. Accordingly, the viscosity and flow rate of the molten glass should be considered when determining the appropriate immersion depth, distance from the root, and shape of the immersion tool for any particular installation and process parameters.

It should also be apparent that the forming apparatus need not include a forming roll on which molten glass is distributed. For example, edge directors as described herein may be useful for other processes, such as wherein a glass ribbon is drawn from the bottom edge of the converging forming surfaces and drawn downward by pulling rolls with no forming roll disposed therebetween. Indeed, other forming apparatus without converging forming surfaces may be employed. For example, slot draw apparatus, wherein a ribbon of molten glass issues from a slot at the bottom of a vessel, may undergo lateral contraction. Accordingly, edge directors as disclosed herein may be used with such slot draw apparatus, or any other down draw apparatus (i.e., where molten glass is drawn downward from a vessel as a molten glass ribbon), the immersion tool of each edge director immersed at least partially in edge portions of the molten glass ribbon.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A glass forming apparatus, comprising:
a forming body comprising a first end and a second end opposite the first end and configured to receive a flow of molten glass and wherein the molten glass flows from the forming body as a molten glass ribbon along a draw plane;
an edge director assembly comprising a wire immersion tool arranged below the forming body and positioned such that the wire immersion tool extends in a direction from the first end toward a first vertical plane extending through the forming body orthogonal to the draw plane and bisecting the forming body, at least a portion of the wire immersion tool positioned between the first vertical plane and a second vertical plane parallel to the first vertical plane and coincident with the first end of the forming body.

2. The glass forming apparatus claim 1, wherein a maximum diameter of the wire immersion tool is in a range from about 1 mm to about 10 mm.

3. The glass forming apparatus of claim 1, wherein the wire immersion tool comprises a platinum group metal.

4. The glass forming apparatus of claim 1, wherein the wire immersion tool is movable in a vertical direction.

5. The glass forming apparatus of claim 1, wherein the wire immersion tool is movable in a horizontal direction.

6. The glass forming apparatus of claim 1, wherein the wire immersion tool is rotatable about an axis of rotation parallel to the draw plane.

7. The glass forming apparatus of claim 1, wherein the wire immersion tool is rotatable about a horizontal axis orthogonal to the draw plane.

8. The glass forming apparatus of claim 1, wherein the forming body comprises a pair of converging forming surfaces joining along a bottom edge of the forming body, the bottom edge lying in the draw plane.

9. The glass forming apparatus of claim 1, further comprising a forming roll rotatable about an axis of rotation and positioned below and spaced apart from the edge director, the forming roll positioned to receive the molten glass ribbon on a surface thereof.

10. The glass forming apparatus of claim 9, further comprising a pair of counterrotating pulling rolls positioned below and spaced apart from the forming roll, the pair of counterrotating pulling rolls arranged to receive therebetween a second glass ribbon from the forming roll.

11. The glass forming apparatus of claim 1, wherein the wire immersion tool is connected to an electrical power supply configured to pass an electrical current through the wire immersion tool.

12. The glass forming apparatus of claim 11, wherein the wire immersion tool comprises an electrically conductive sheath disposed about the wire immersion tool and an electrically isolating material disposed between the wire immersion tool and the electrically conductive sheath that electrically isolates the wire immersion tool from the electrically conductive sheath.

13. The glass forming apparatus of claim 12, wherein the electrically conductive sheath comprises platinum.

14. The glass forming apparatus of claim 12, wherein the electrically isolating material comprises a ceramic refractory material.

15. The forming apparatus of claim 1, wherein the glass forming apparatus further comprises a DC power supply electrically connected between the forming body and the edge director assembly.

16. The glass forming apparatus of claim 11, wherein the glass forming apparatus further comprises a DC power supply electrically connected between the forming roll and the electrically conductive sheath.

17. The glass forming apparatus of claim 1, wherein the wire immersion tool is positioned below and spaced apart from the forming body.

18. A method of forming a glass ribbon, comprising:
flowing molten glass from a forming body as a molten glass ribbon;
contacting an edge portion of the molten glass ribbon with an edge director assembly, the edge director assembly comprising a wire immersion tool at least partially immersed in the edge portion.

19. The method of claim 18, wherein the edge director assembly is positioned below and spaced apart from the forming body.

20. The method of claim 18, further comprising heating the wire immersion tool with an electrical current directed therethrough.

21. The method of claim 20, wherein a DC power supply is connected between the edge director assembly and the forming roll, the method further comprising controlling adhesion of the molten glass layer to the forming roll by controlling at least one of a voltage or an electrical current supplied by the DC power supply.

22. The method of claim 21, wherein the voltage is controlled in a range from about −3 volts to about +3 volts.

23. The method of claim 21, wherein the electrical current is controlled in a range from about 0 amps to about 5 amps.

24. The method of claim 20, wherein a DC power supply is connected between the edge director assembly and the forming body.

25. The method of claim 21, wherein the edge director assembly comprises an electrically conductive sheath disposed about the wire immersion tool, an electrically isolating material is disposed between the electrically conductive sheath and the wire immersion tool, and the DC power supply is electrically connected to the electrically conductive sheath.

26. The method of claim 18, further comprising receiving the molten glass ribbon on a rotating forming roll spaced apart from and below the edge director, the molten glass ribbon forming a molten glass layer over at least a portion of the forming roll.

27. The method of claim 26, further comprising drawing the molten glass layer from the forming roll as a second glass ribbon.
